(19) United States
(12) Patent Application Publication
(10) Pub. No.: US 2015/0199920 A1
(43) Pub. Date: Jul. 16, 2015

(54) SYSTEMS AND METHODS FOR OPERATING ROOM SIMULATION TRAINING

(71) Applicant: Case Western Reserve University, Cleveland, OH (US)

(72) Inventors: James R. Rowbottom, Broadview Heights, OH (US); Jacob Schwartz, Manhattan Beach, CA (US); Alexis Schilf, Carol Stream, IL (US); Yueshuo Xu, Shaker Heights, OH (US); Chad Harding, Avon, IN (US); Levi DeLuke, Vancleave, MS (US)

(21) Appl. No.: 14/593,503

(22) Filed: Jan. 9, 2015

Related U.S. Application Data
(60) Provisional application No. 61/925,935, filed on Jan. 10, 2014.

(51) Int. Cl. G09B 23/28; G06K 7/10

(52) U.S. Cl. CPC G09B 23/28; G06K 7/10366

(57) ABSTRACT

One aspect of the present disclosure relates to a system that can provide training for an operating room staff member. The system can include a hand device with a housing that can be configured to receive an input of a device from the operating room staff member. Inside the housing, the hand device can include a non-transitory memory that stores instructions and a processor that can be configured to execute the instructions to at least: provide an instruction related to placing a surgical instrument in the hand device to the operating room staff member; receive a test surgical instrument from the operating room staff member in response to the instruction; and determine whether the test surgical instrument matches the instructed surgical instrument.

### RELATED APPLICATIONS

This application claims the benefit of U.S. Provisional Application No. 61/925,935, filed Jan. 10, 2014, entitled “OPERATING ROOM SIMULATION TRAINING SYSTEM AND METHOD.” This provisional application is hereby incorporated by reference in its entirety for all purposes.

### TECHNICAL FIELD

The present disclosure relates generally to simulation training and, more specifically, to systems and methods that can provide operating room simulation training.

### BACKGROUND

For smooth operation of the operating room (“OR”), nursing staff members must be well educated to perform critical tasks. Student nurses participate in classroom lecture, labs, and simulated surgeries prior to entering the OR. Preceptor guided clinical experience allows the student to demonstrate increased competence, responsibility, and autonomy, where proficiency can be achieved anywhere from 8-12 months of OR clinical experience. A proficient student can use knowledge of anatomy and the associated surgical procedure to anticipate the needs of the surgical team, assuring smooth and efficient progress through the operation. For example, the proficient student should be able to pass instruments to the surgical team firmly, decisively, and in the proper position for immediate use with no wasted motion. Accordingly, the student should be able to identify and classify various surgical instruments that are placed on tables in the OR in a planned, organized, standardized, and functional manner. For example surgical instruments are divided into categories (families) based on the associated basic surgical maneuvers and then assembled into sets that can be used to perform specific surgical procedures.

### SUMMARY

The present disclosure relates generally to simulation training and, more specifically, to systems and methods that can provide operating room simulation training.

In one aspect, the present disclosure can include a system that can provide training for an operating room staff member. The system can include a plurality of surgical instruments. The system can also include a hand device that includes a housing configured to receive the surgical instrument. Within the housing, the hand device can include a non-transitory memory that stores instructions and a processor that can be configured to execute the instructions. An instruction can be provided to the operating room staff member related to a surgical instrument. One of the plurality of surgical instruments can be received from the operating room staff member in response to the instruction. The housing device can then determine whether the one of the plurality of surgical instruments matches the instructed surgical instrument.

In another aspect, the present disclosure can include hand device comprising a housing configured to receive a surgical instrument. The hand device can include, within the housing, a non-transitory memory to store computer-executable instructions and a processor coupled to the non-transitory memory and configured to execute the instructions. An instruction can be provided to the operating room staff member related to a surgical instrument. One of the plurality of surgical instruments can be received from the operating room staff member in response to the instruction. The housing device can then determine whether the one of the plurality of surgical instruments matches the instructed surgical instrument.

In a further aspect, the present disclosure can include a method for training an operating room staff member. The method can include the step of providing, by a hand device comprising a processor, an instruction related to placing a surgical instrument in the hand device to the operating room staff member. The method can also include the step of receiving, by the hand device, a test surgical instrument from the operating room staff member in response to the instruction. The method can also include determining, by the hand device, whether the test surgical instrument matches the instructed surgical instrument.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a schematic block diagram showing a system that can be used to provide training to operating room staff in accordance with another aspect of the present disclosure;

FIG. 2 is schematic block diagram of a hand device that can provide training to operating room staff in accordance with an aspect of the present disclosure;

FIG. 3 is a schematic block diagram showing the hand device shown in FIG. 1 interfacing with a surgical instrument;

FIG. 4 is a schematic block diagram showing the hand device interfacing with a surgical instrument shown in FIG. 2 with a reader device to scan an identification tag on the surgical device;

FIG. 5 is a schematic block diagram showing the hand device interfacing with a surgical instrument with a reader device to scan an identification tag on the surgical device of FIG. 3 with greater details of the hand device;

FIG. 6 is a process flow diagram illustrating a method for training an operating room staff member in accordance with another aspect of the present disclosure; and

FIG. 7 is a process flow diagram illustrating another method for training an operating room staff member in accordance with yet another aspect of the present disclosure.

### DETAILED DESCRIPTION

### I. Definitions

In the context of the present disclosure, the singular forms “a,” “an” and “the” can also include the plural forms, unless the context clearly indicates otherwise. The terms “comprises” and/or “comprising,” as used herein, can specify the presence of stated features, steps, operations, elements, and/or components, but do not preclude the presence or addition of one or more other features, steps, operations, elements, components, and/or groups. As used herein, the term “and/or” can include any and all combinations of one or more of the associated listed items. Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “operating room staff member” can refer to any person in an operating room supporting a surgeon. Examples of an operating room staff member can include: a registered nurse, a practical nurse, a nursing student, a surgical technologist, a surgical technologist student, a medical student, a medical resident, and other medical professionals that require training for the operating room.

As used herein, the term “operating room” can refer to a facility in a hospital or other setting (e.g., a surgery center) where surgical operations are carried out on a patient in a sterile environment.

As used herein, the term “operation” can refer to a medical procedure involving an incision with surgical instruments.

As used herein, the term “training” can refer to the acquisition of knowledge, skills, and competencies as a result of teaching practical skills and knowledge related to specific skills required in the operating room. For example, the practical skills can be related to the surgical instruments used during a specific operation.

As used herein, the term “simulation” can refer to a definition, imitation, or enactment of a real-world process or system. An operating room simulation can relate to an enactment of an operating room using surgical instruments and a computerized hand device.

As used herein, the term “surgical instrument” can refer to a specially designed tool or device for performing specific actions of carrying out desired effects during surgery. For example, a surgical instrument can modify biological tissue, provide for viewing biological tissue, and the like. The term “instrument” can be used interchangeably with “surgical instrument.”

As used herein, the term “hand device” can refer to a computerized device (e.g., including a non-transitory memory and a processor) that can be used in a surgical training simulation. The hand device can be configured to receive a surgical instrument. In some instances, the hand device can be configured to receive a surgical instrument (e.g., a housing can be configured to receive the surgical instrument). In other instances, the hand device can be physically and/or electronically coupled to another device configured to receive the surgical instrument (e.g., a housing can include the memory and processor and a separate housing can be configured to receive the surgical instrument).

As used herein, the term “patient” can refer to any warm-blooded organism including, but not limited to, a human being, a pig, a rat, a mouse, a dog, a cat, a goat, a sheep, a horse, a monkey, an ape, a rabbit, a cow, etc. The terms “patient” and “subject” can be used interchangeably herein.

As used herein, the term “computing device” can refer to a device that includes a non-transitory memory that stores instructions and a processor configured to execute the instructions to facilitate performance of one or more operations. In some instances, the non-transitory memory can also store data corresponding to the one or more operations. The term “mobile computing device” can refer to a subset of computing devices that include a touch screen. Examples of mobile computing devices can include: a smart phone, a tablet computer, or a laptop computer.

### II. Overview

The present disclosure relates generally to simulation training and, more specifically, to systems and methods that can provide operating room simulation training. As an example, the operating room simulation can be used to teach the operating room staff members to identify and classify various surgical instruments that can be used during a surgical procedure. The goal of the operating room simulation can be for the operating room staff to pass the correct surgical instrument to the doctor on the surgical team firmly, decisively, and in the proper position for immediate use.

The systems and methods of the present disclosure can employ a stimulator that allows individualized training in a home or classroom setting, as well as in a more formal simulation environment. The simulator can be used to allow an operating room staff member to practice recognizing instruments, setting up the instruments for various surgeries, handing off instruments in a sequential manner, and anticipate the next instrument required. In some instances, the system can allow for the ability to select from a library of different surgical cases, which can be tailored by degree of difficulty and customized for individual surgeons or staff. The simulator can allow the instrument to be handed to a hand device, which can accept the instrument and identify whether it is correct and/or if it is in the right orientation. Speed and/or accuracy can be graded for the operating room staff member and progress can be tracked over time.

### III. Systems

One aspect of the present disclosure can include a system that can provide training to operating room staff. The system can employ a hand device (or a hand device linked to a computing device), which can receive a surgical instrument from an operating room staff member, determine whether the surgical instrument is correct, the speed at which the surgical instrument is handed to the hand device, a pressure related to the surgical instrument being handed off, and/or the orientation of the surgical instrument. In some instances, the hand device can be coupled to a laptop computer or other mobile computing device that can allow for flexible use of the system in different locations (e.g., at home, in a breakroom before surgery, in a classroom, etc.).

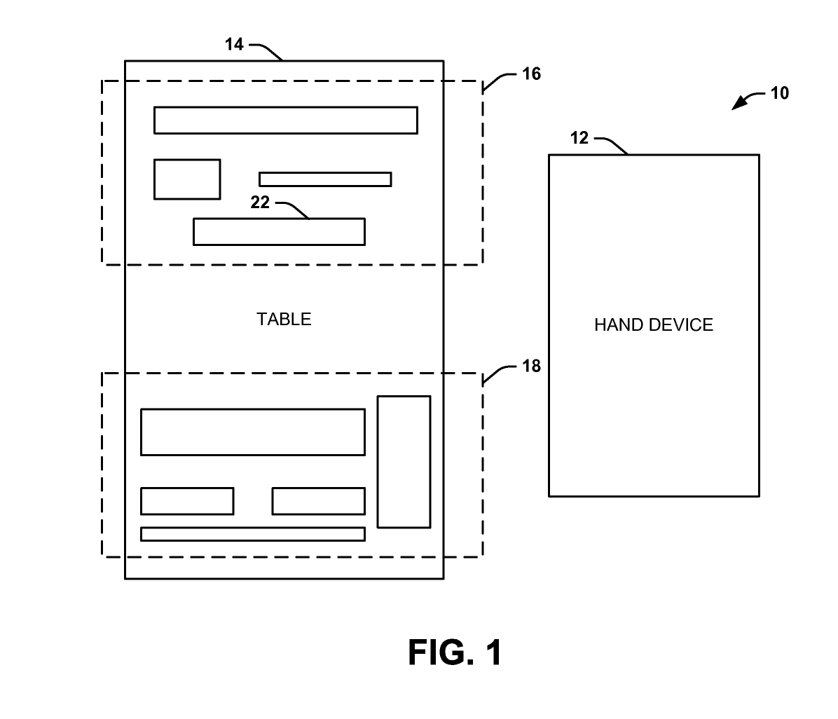

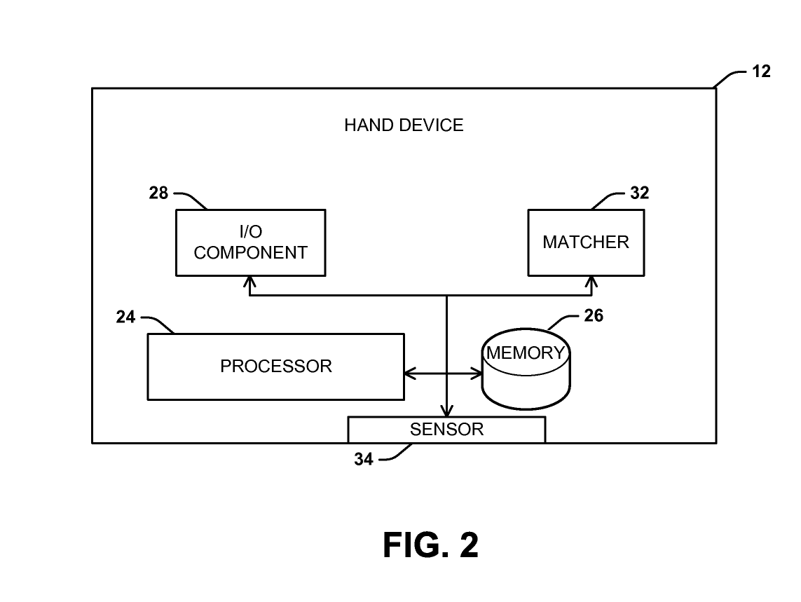

FIG. 1 illustrates an example of a system 10 that can provide training to operating room staff employing a hand device 12 (or a hand device linked to a computing device), according to an aspect of the present disclosure. FIG. 1, as well as associated FIGS. 2-5, is schematically illustrated as a block diagram with the different blocks representing different components. The functions of one or more of the components (e.g., the hand device 12) can be implemented by computer program instructions. These computer program instructions can be provided to a processor of a general purpose computer, special purpose computer, and/or other programmable data processing apparatus to produce a machine, such that the instructions, which execute via the processor of the computer and/or other programmable data processing apparatus, create a mechanism for implementing the functions of the components specified in the block diagrams.

These computer program instructions can also be stored in a non-transitory computer-readable memory that can direct a computer or other programmable data processing apparatus to function in a particular manner, such that the instructions stored in the non-transitory computer-readable memory produce an article of manufacture including instructions, which implement the function specified in the block diagrams and associated description.

The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions of the components specified in the block diagrams and the associated description.

Accordingly, the components described herein can be embodied at least in part in hardware and/or in software (including firmware, resident software, micro-code, etc.). Furthermore, aspects of the components can take the form of a computer program product on a computer-usable or computer-readable storage medium having computer-usable or computer-readable program code embodied in the medium for use by or in connection with an instruction execution system. A computer-usable or computer-readable medium can be any non-transitory medium that is not a transitory signal and can contain or store the program for use by or in connection with the instruction or execution of a system, apparatus, or device. The computer-usable or computer-readable medium can be, for example but not limited to, an electronic, magnetic, optical, electromagnetic, infrared, or semiconductor system, apparatus or device. More specific examples (a non-exhaustive list) of the computer-readable medium can include the following: a portable computer diskette; a random access memory; a read-only memory; an erasable programmable read-only memory (or Flash memory); and a portable compact disc read-only memory. In some instances, the hand device 12 can be linked to a mobile computing device.

As shown in FIG. 1, one aspect of the present disclosure can include a 10 that can provide training to operating room staff. The system 10 can simulate operating room conditions without a patient and/or a doctor being present. In some instances, the system 10 can allow for an operating room staff member to practice recognizing instruments. In other instances, the system 10 can allow for an operating room staff member to practice setting up the instruments for various surgeries. In still other instances, the system 10 can allow for an operating room staff member to practice handing off instruments in a sequential manner. In further instances, the system 10 can allow for an operating room staff member to anticipate the next instrument required. Accordingly, the system 10 can provide a qualified operating room staff member who can identify and classify various surgical instruments that can be used during a surgical procedure so that they can pass the correct surgical instrument to a doctor on the surgical team firmly, decisively, and in the proper position for immediate use.

The system 10 can include components including at least a hand device 12 and a table 14. The table 14 can include one or more groups of surgical instruments 16, 18, each having one or more individual surgical instruments 22. Although two groups are illustrated, it will be understood that more groups or fewer groups can be used for a surgical procedure. Additionally, any number of surgical instruments can be included within a group. In some instances, the table 14 can include a component (e.g., a pad) that includes one or more sensors to detect that the groups 16, 18 contain correctly grouped surgical instruments and/or that the groups are correctly positioned on the table. For example, the sensors can detect identification tags associated with the surgical instruments to make these determinations.

In some instances, the hand device 12 can be embodied in a simulator device (e.g., a computing device) and/or coupled to the stimulator device that can allow an operating room staff member to practice recognizing instruments, setting up the instruments for various surgeries, handing off the correct instruments in a sequential manner in the right orientation, and anticipate the next instrument required. The simulator can include a memory 26 that can store a library of various test modules and learning modules corresponding to different surgeries and/or different doctor or staff member preferences with different speed and/or difficulty modes.

The hand device 12 can include a portion for receiving a surgical instrument 22 representing a doctor's hand and can include and/or be coupled to a computing device (or mobile computing device). For example, the portion for receiving the surgical instrument can include a hand-shaped device configured to receive the surgical instrument. However, the portion for receiving the surgical instrument need not be shaped like a hand and can merely be configured to receive the surgical instrument. For example, the hand device 12 can be a part of a larger robotic surgery simulator (e.g., with a wrist and elbow and a second hand/arm) or can just be a hand coupled to a computing device.

Illustrated in FIG. 2 is a configuration of components of the hand device 12 or a computing device associated with the hand device. The computing device communicably coupled to the hand device can be any type of computing device and/or mobile computing device. Examples of such devices include laptop computers, desktop computers, touch screen devices, tablet computing devices, telephone computing devices, etc. The components can include an I/O component 28, a matcher 32, and a sensor 34. At least a portion of the components can be stored in the non-transitory memory 26 and executed by the processor 24.

As an example, the I/O component 28 can provide an instruction related to a certain surgical instrument. For example, the instruction can be an audio instruction and/or a visual cue/instruction. In some instances, the instruction can be based on a program dedicated to a surgical procedure, dedicated to a specific surgeon's preference, dedicated to a specific operating room staff member's preference, or the like. In some instances, the instruction can trigger a timer to start monitoring the time for the operating room staff member to give the surgical instrument to the hand device 12.

Based on the instruction, the operating room staff member can select a surgical instrument (e.g., surgical instrument 22 from the table 14 of FIG. 1) and give the surgical instrument to the hand device 12. For example, the operating room staff member can place the surgical instrument in a portion for receiving the surgical instrument of the hand device 12. In some instances, this causes the timer to stop monitoring the time. For example, the score of the program can be related to the time for the operating room staff member to put the surgical instrument in the hand device 12.

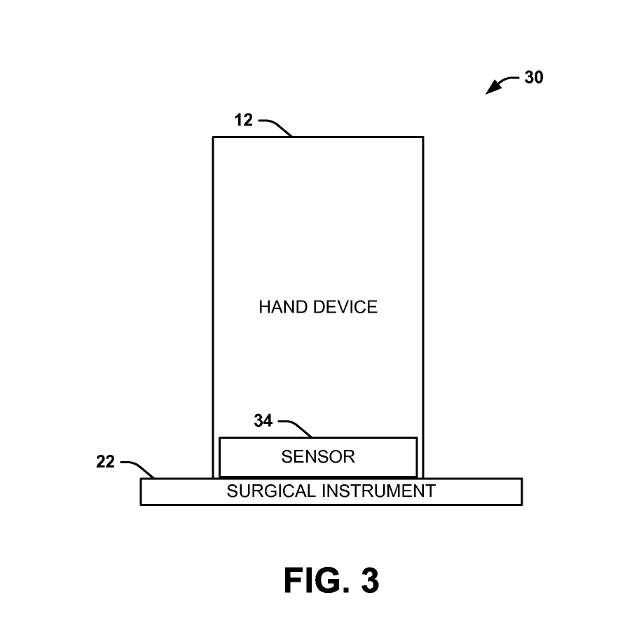

As shown in FIG. 3, the hand device 12 can include a sensor 34 configured to detect the presence of the surgical instrument 22. For example, the sensor 34 can include a pressure sensor that can be configured to determine a pressure with which the operating room staff member handed the surgical instrument 22 to the hand device 12. As another example, the score of the program can be related to the pressure at which the staff member puts the surgical instrument in the hand device 12.

Upon receiving the surgical instrument, referring again to FIG. 2, a matcher 32 of the hand device 12 can determine if the surgical instrument matches the requested surgical instrument. Based on the output of the matcher 32, in some instances, the hand device 12 can produce an output distinguishing whether the surgical instrument 22 matches the requested surgical instrument or does not match the surgical instrument. As an example, the score of the program can be related to whether the surgical instrument 22 matches the requested surgical instrument. In some instances, it the surgical instrument matches the requested surgical instrument, other secondary considerations (e.g., pressure at which the device is handed to the hand device 12, orientation of the surgical instrument, the time to place the surgical instrument, or the like).

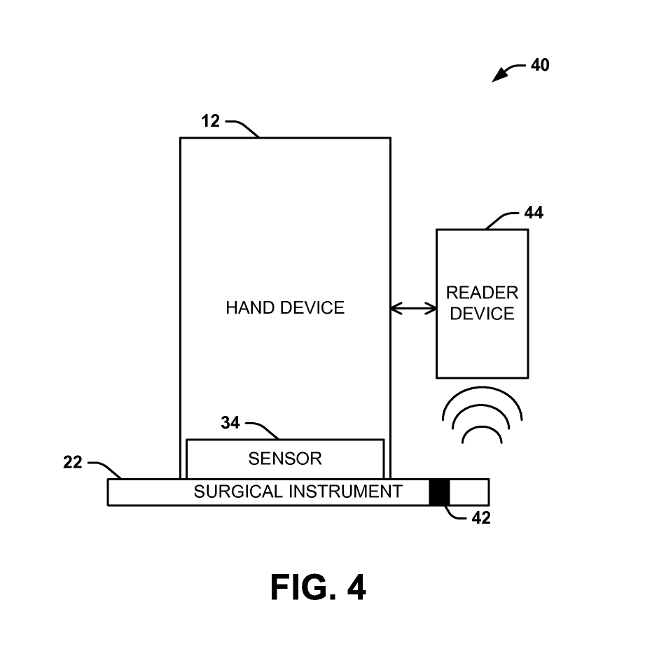

According to one example, the matcher 32 can base its determination on a comparison between information about the surgical instrument 22 and information about the requested surgical instrument. Referring now to FIG. 4, the surgical instrument 22 can include an identification tag 42 (e.g., a radio frequency identification (RFID) tag, a near field communication (NFC) tag, a bar code tag, or other type of identification tag) that can include one or more identifying features of the surgical instrument. The hand device 12 can include a record of the identification tag 42 and the surgical instrument 22 in the memory 26. Additionally, the hand device 12 can be coupled to a reader device 44 that can read information from the identification tag 42. The reader device 44 can be located sufficiently close to the receiving point for the surgical instrument 22 to enable detection. For example, when the identification tag 42 is a RFID tag, the reader device 44 can be an RFID detector. The matcher 32 of FIG. 3 can use the signal detected by the reader device 44 from the identification tag 42 to determine at least whether the surgical instrument 22 is properly selected. For example, the matcher 32 can match the information included on the identification tag of the surgical instrument 22 to the surgical instrument requested. As another example, the matcher 32 can determine whether the surgical instrument 22 is correctly positioned in the correct orientation for seamless use by the requesting surgeon.

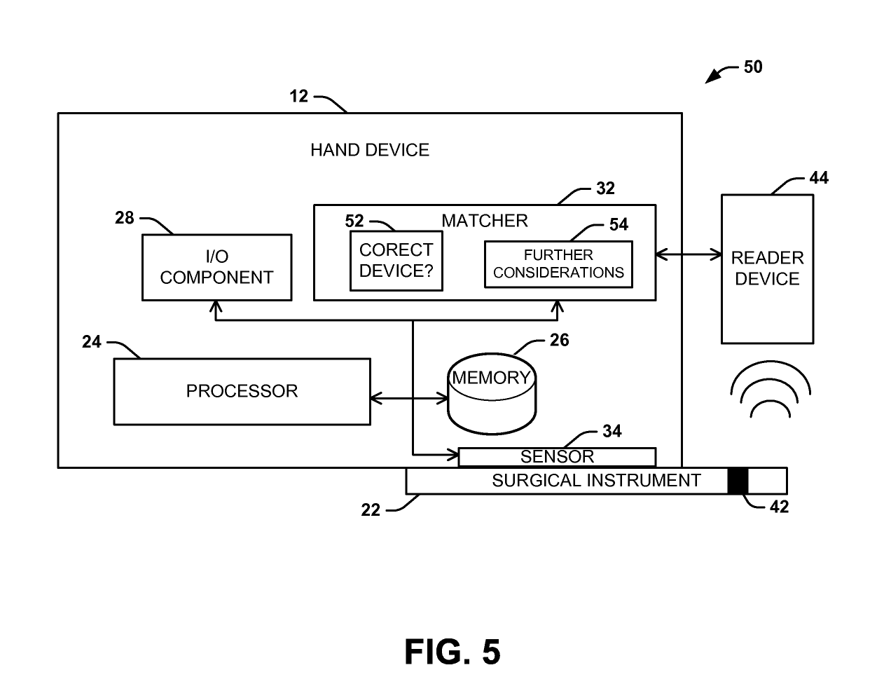

Referring now to FIG. 5, illustrated is another example of components of the hand device 12. In FIG. 5, the matcher 32 can include a correct device component 52 and a further considerations component 54. The correct device component 52 can determine whether the surgical instrument 22 matches the requested surgical instrument. The further considerations component 54 can determine whether the orientation of the surgical instrument is correct, the time to place the surgical instrument is rapid enough, and/or the pressure at which the surgical instrument is placed into the hand device is hard enough. The hand device 12 is not limited to the components illustrated; for example, the hand device 12 may include other components, such as one or more servos, an LED light, a sound card, an output device, etc. For example, the sensor 34 can include a pressure sensor can be located in the palm of the hand device and can trigger the servos to close the hand upon receiving the surgical instrument 22. As another example, feedback (e.g., audio, visual, or the like) can be provided by the hand device 12 based on one or more of the determinations of speed, accuracy, and/or correctness of the surgical instrument 22. The feedback can be stored as a record of progress for the operating room staff (e.g., for the individual user and for the staff as a whole).

### IV. Methods

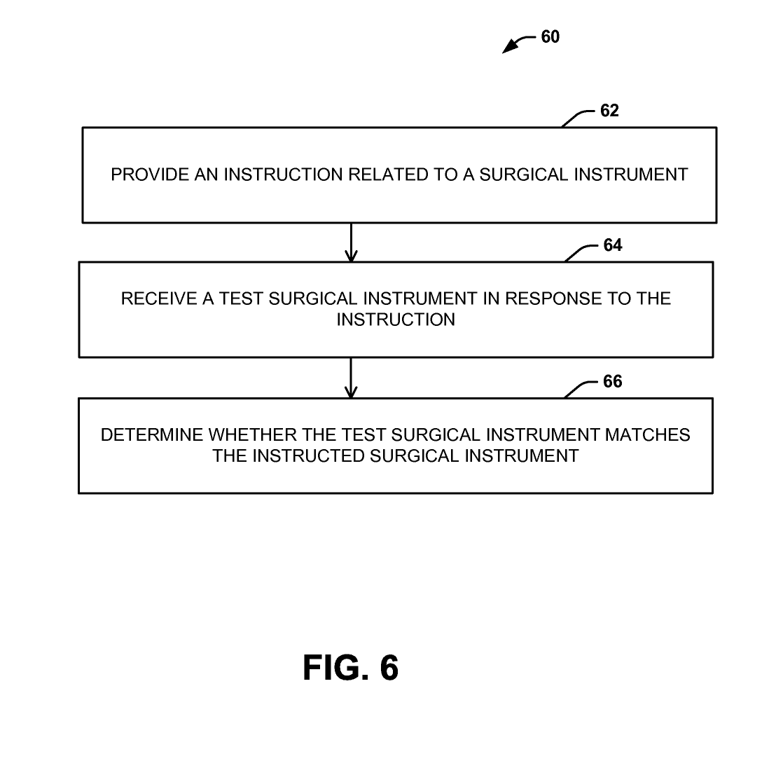

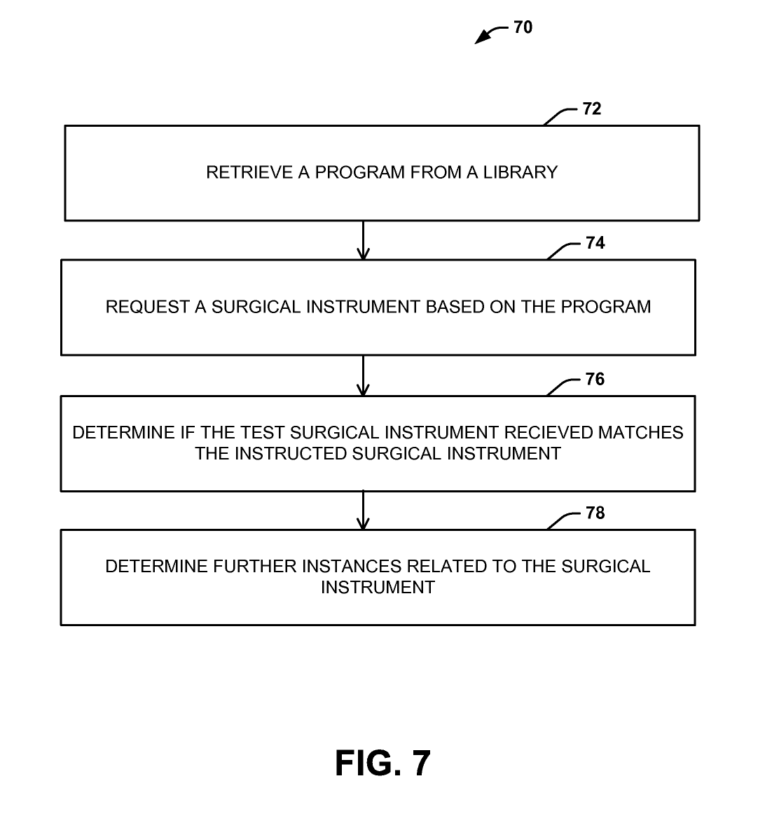

Another aspect of the present disclosure can include methods that can provide training to operating room staff, according to an aspect of the present disclosure. The system can employ a hand device, which can receive a surgical instrument from an operating room staff member, determine whether the surgical instrument is correct, the speed at which the surgical instrument is handed to the hand device, a pressure related to the surgical instrument being handed off, and/or the orientation of the surgical instrument. An example of a method 60 that can provide training for an operating room staff member is shown in FIG. 6. Another example of a method 70 that can provide training for an operating room staff member is shown in FIG. 7.

The methods 60 and 70 of FIGS. 6 and 7, respectively, are illustrated as process flow diagrams with flowchart illustrations. For purposes of simplicity, the methods 60 and 70 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 60 and 70.

One or more blocks of the respective flowchart illustrations, and combinations of blocks in the block flowchart illustrations, can be implemented by computer program instructions. These computer program instructions can be stored in memory and provided to a processor of a general purpose computer, special purpose computer, and/or other programmable data processing apparatus to produce a machine, such that the instructions, which execute via the processor of the computer and/or other programmable data processing apparatus, create mechanisms for implementing the steps/acts specified in the flowchart blocks and/or the associated description. In other words, the steps/acts can be implemented by a system comprising a processor that can access the computer-executable instructions that are stored in a non-transitory memory.

The methods 60 and 70 of the present disclosure may be embodied in hardware and/or in software (including firmware, resident software, micro-code, etc.). Furthermore, aspects of the present disclosure may take the form of a computer program product on a computer-usable or computer-readable storage medium having computer-usable or computer-readable program code embodied in the medium for use by or in connection with an instruction execution system. A computer-usable or computer-readable medium may be any non-transitory medium that can contain or store the program for use by or in connection with the instruction or execution of a system, apparatus, or device.

Referring to FIG. 6, an aspect of the present disclosure can include a method 60 for providing training for an operating room staff member. The method 60 can employ a stimulator device (e.g., hand device 12 or the hand device and a linked computer) that can allow for individualized training in a home or classroom setting, as well as in a more formal simulation environment. The simulator device can be used to allow an operating room staff member to practice recognizing instruments, setting up the instruments for various surgeries, handing off instruments in a sequential manner, and anticipate the next instrument required. Speed and/or accuracy can be graded for the operating room staff member and progress can be tracked over time.

At 62, an instruction can be provided (e.g., by hand device 12 or a computing device associated with the hand device) related to a surgical instrument (e.g., related to a program for a surgeon or staff member preferences, a surgical procedure, etc.). In some instances, the instruction can be provided as an audio instruction. In other instances, the instructions can be provided as a video instruction. In still other instances, the instruction can be provided as a combination of an audio instruction and a video instruction.

At 64, a test surgical instrument (e.g., surgical instrument 22) can be received (e.g., from an operating room staff member) in response to the instruction. The test surgical instrument can be applied to the hand device with a pressure and within a certain time. In some instances, the hand device can measure the pressure at which the surgical instrument is given to the hand device. This can correlate to the level of surety the operating room staff member has regarding the correctness of the device. In other instances, the hand device can measure the time it takes for the operating room staff member to give the surgical device to the hand device. The time can be used to indicate surety of the operating room staff member has in choosing the device compared to other devices on a surgical table (e.g., table 14). In some instances, the surgical table can be prepared for a certain surgery. In other instances, the surgical table can be prepared with a surgeon's preferred orientation. In still other instances, the surgical table can be prepared by the operating room staff member.

At 66, a determination can be made (e.g., by matcher 32) of whether the test surgical instrument matches the instructed surgical instrument. In some instances, the hand device can be coupled to a sensor and/or reader to read a tag (e.g., an RFID tag) affixed to the surgical device. The matcher can consult a list of tag identification information and cross reference the scanned tag on the surgical device with the correct tag information. If the matcher indicates that the device is incorrect, an output can be produced (e.g., a sound or a light) indicating that the device is incorrect. If the matcher indicates that the device is correct, further instances related to the surgical instrument (e.g., the orientation of the surgical instrument, the time to place the surgical instrument, and/or the pressure at which the surgical instrument is placed into the hand device) can be examined. If the other instances are correct, an output can be produced (e.g., a different sound or a different light) indicating that the surgical instrument is correct. As another example, the output can be produced (e.g., the different sound or the different light) when the surgical instrument is correct without requiring examination of the further instances.

FIG. 7 illustrates another method 70 for providing training for an operating room staff member. Like the method 60, the method 70 can employ a stimulator device (e.g., hand device 12 or the hand device and a linked computer) that can allow for individualized training in a home or classroom setting, as well as in a more formal simulation environment to enable accelerated learning of instrument identification, standard table set-up, accuracy, speed of passing instruments, and, ultimately, the anticipation of the next surgical maneuver.

At 72, a program can be received from a library (e.g., stored within a non-transitory memory of a hand device 12 or computer associated with the hand device). In some instances, the program can be specific to a certain type of surgical procedure. In other instances, the program can be specific to a certain surgeon's or staff's preferences. In still other instances, the program can have a degree of difficulty based on the specific operating room staff member.

At 74, a surgical instrument can be requested (e.g., stored within a non-transitory memory of a hand device 12 or computer associated with the hand device) based on the program. In some instances, the instruction can be provided as an audio instruction. In other instances, the instructions can be provided as a video instruction. In still other instances, the instruction can be provided as a combination of an audio instruction and a video instruction.

At 76, it can be determined (e.g., by the correct device component 52 of matcher 32) whether the surgical instrument received matches the instructed surgical instrument. In some instances, the hand device can be coupled to a sensor and/or reader to read a tag (e.g., an RFID tag) affixed to the surgical device. The matcher can consult a list of tag identification information and cross reference the scanned tag on the surgical device with the correct tag information. If it is determined that the surgical instrument received matches the instructed surgical instrument, at 78, further instances related to the surgical instrument can be examined (e.g., by the further considerations component 54 of the matcher 32). For example, the further instances can be related to the orientation of the surgical instrument, the time to place the surgical instrument, and/or the pressure at which the surgical instrument is placed into the hand device. If the further instances are correct, an output can be produced (e.g., a sound or a light). If the surgical instrument does not match and/or the surgical instrument does not satisfy one or more of the further considerations, a different output can be produced (e.g., a different sound or a different light). In other instances, different outputs (e.g., sounds or lights) can be produced for each of the different further considerations.

From the above description, those skilled in the art will perceive improvements, changes and modifications. Such improvements, changes and modifications are within the skill of one in the art and are intended to be covered by the appended claims.

What is claimed is:

1. A system that provides training for an operating room staff member, the system comprising:
a plurality of surgical instruments; and
a hand device comprising a housing configured to receive the surgical instrument, the hand device comprising within the housing:
a non-transitory memory to store computer-executable instructions; and
a processor, coupled to the non-transitory memory, configured to execute the instructions to at least:
provide an instruction to the operating room staff member related to a surgical instrument;
receive one of the plurality of surgical instruments from the operating room staff member in response to the instruction; and
determine whether the one of the plurality of surgical instruments matches the instructed surgical instrument.

2. The system of claim 1, wherein each of the plurality of surgical instruments comprises a unique identification tag.

3. The system of claim 2, wherein the hand device stores a record of the unique identification tags corresponding to the plurality of surgical instruments on the non-transitory memory.

4. The system of claim 2, wherein the processor is configured to consult the record of the unique identification tags to determine whether the one of the plurality of surgical instruments matches the instructed surgical instrument.

5. The system of claim 2, wherein the hand device is associated with a reader device configured to scan the identification tag of the one of the plurality of surgical instruments.

6. The system of claim 5, wherein the reader device is attached to the hand device.

7. The system of claim 5, wherein the hand device comprises the reader device.

8. The system of claim 2, wherein the processor is further configured to determine whether the test surgical instrument is placed in a proper orientation in the hand device based on a position of the identification tag.

9. The system of claim 8, wherein the position of the identification tag is determined based on a scan of the identification tag of the one of the plurality of surgical instruments; and
wherein the correct position of the one of the plurality of surgical instruments is stored in the memory.

10. A hand device comprising a housing configured to receive a surgical instrument, comprising within the housing:
a non-transitory memory to store computer-executable instructions; and
a processor, coupled to the non-transitory memory, configured to execute the instructions to at least:
provide an instruction to an operating room staff member related to a surgical instrument;
receive a test surgical instrument from a plurality of surgical instruments from the operating room staff member in response to the instruction; and
determine whether the test surgical instrument matches the instructed surgical instrument.

11. The hand device of claim 10, wherein each of the plurality of surgical instruments comprises a unique identification tag.

12. The hand device of claim 11, wherein the hand device is associated with a reader device configured to read the identification tag of the test surgical instrument.

13. The hand device of claim 12, wherein the reader device is configured to scan the identification tag of the test surgical instrument, and
wherein the processor is configured to determine whether the test surgical instrument matches the instructed surgical instrument based on the scan of the identification tag.

14. The hand device of claim 11, wherein the processor is further configured to execute the instructions to at least determine whether the test surgical instrument is placed in a proper orientation in the hand device based on a position of the identification tag.

15. The method of claim 14, wherein processor is further configured to execute the instructions to at least consult the non-transitory memory for information related to the proper orientation of the instrument in the hand device.

16. A method for training an operating room staff member, comprising the steps of:
providing, by a hand device comprising a processor, an instruction related to placing a surgical instrument in the hand device to the operating room staff member;
receiving, by the hand device, a test surgical instrument from the operating room staff member in response to the instruction; and
determining, by the hand device, whether the test surgical instrument matches the instructed surgical instrument.

17. The method of claim 16, wherein the test surgical instrument comprises an identification tag.

18. The method of claim 17, wherein the step of determining whether the test surgical instrument matches the instructed surgical instrument further comprises scanning, by a reader device associated with the hand device, the identification tag.

19. The method of claim 18, wherein the step of determining whether the test surgical instrument matches the instructed surgical instrument further comprises comparing information on the identification tag to information about the instructed surgical instrument.

20. The method of claim 17, further comprising the step of determining, by the hand device, whether the test surgical instrument is placed in a proper orientation in the hand device based on a position of the identification tag.
